(19) United States
(12) Patent Application Publication
(10) Pub. No.: US 2003/0154162 A1
(43) Pub. Date: Aug. 14, 2003

(54) Credit report retrieval system including voice-based interface

(76) Inventors: John Thomas Danaher, San Luis Obispo, CA (US); Michael Maxwell, San Luis Obispo, CA (US); Justin Depow, San Luis Obispo, CA (US); Scott Meizger, San Luis Obispo, CA (US)

Correspondence Address: MARK J. SPOLYAR, 38 FOUNTAIN ST., SAN FRANCISCO, CA, 94114, US

(21) Appl. No.: 10/364,090

(22) Filed: Feb. 11, 2003

Related U.S. Application Data
(60) Provisional application No. 60/356,267, filed on Feb. 11, 2002.

(51) Int. Cl. G06F 17/60

(52) U.S. Cl. 705/38

(57) ABSTRACT

Methods, apparatuses and systems providing a voice-based interface to credit report retrieval systems allowing users to order credit report data using a telephone or similar device. The present invention provides novel functionality and process flows directed to handling a request from a caller for a credit report, while providing a secure and easy-to-use voice interface. In one embodiment, the functionality associated with the present invention allows a customer to access his/her credit score via a telephone or other suitable voice-based device, and have a credit report mailed to his/her address. The use of a voice interface, instead of a traditional graphical user interface associated with web-based services accessible over a client computer, marks a departure from traditional credit reporting product channels and provides an opportunity to access a large market of consumers who do not regularly access the Internet. In one embodiment, the present invention further provides a novel authentication methodology, especially adapted to telephone network devices and other interfaces having limited text entry capabilities, that minimizes the opportunity for malicious users to glean authenticating information; i.e. personal information presumably known to an individual that may be used to authenticate identity.

### CROSS REFERENCE TO RELATED APPLICATIONS

The present application claims priority from U.S. Provisional Application Ser. No. 60/356,267 filed Feb. 11, 2002 and entitled “Credit Report Retrieval System Featuring Voice-Based Interface,” which is incorporated by reference herein for all purposes.

### FIELD OF THE INVENTION

The present invention relates to credit report retrieval systems and, more particularly, to a credit report retrieval system including a voice-based interface allowing for the ordering and retrieval of credit report information using a telephone or other voice-based network device.

### BACKGROUND OF THE INVENTION

Services providing credit reporting data to individual consumers are gaining widespread acceptance in light of increasing concern and attention to identity theft. Identity theft or fraud refers to crimes in which someone wrongfully obtains and uses another person's personal information, such as social security or financial account numbers, in a fraudulent or other deceptive manner for economic gain. Common activities associated with identity theft include opening credit card or other credit accounts using the victim's identity and charging against these accounts to purchase goods and services without the intention of paying off the ensuing debts.

Credit reporting services offer consumers the ability not only to gauge their personal credit standing, but also to monitor their credit histories for signs of identity theft. Such credit report providers typically offer their services over the Internet in light of the inherent advantages associated with ordering and viewing credit report information using a network-enabled client device, such as a personal computer. The Internet is a global network of millions of computers belonging to various commercial and non-profit entities such as corporations, universities, and research organizations. The computer networks of the Internet are connected by gateways that handle data transfer and conversion of messages from a sending network to the protocols used by a receiving network. The Internet's collection of networks and gateways generally use the TCP/IP protocol for message transfer. TCP/IP is an acronym for Transmission Control Protocol/Internet Protocol, a software protocol suite initially developed by the Department of Defense. Typically, the computers connected to a wide area network such as the Internet are identified as either servers or clients. A server is a computer that stores files that are available to other computers connected to the network. A client is a computer connected to the network that accesses the files and other resources provided by a server. To obtain information from a server, a client computer makes a request for a file or information located on the server using a specified protocol, such as HTTP. Upon receipt of a properly formatted request, the server transmits the file to the client computer.

The increasing use of wide area networks, such as the Internet, has resulted in an explosion in the provision of on-line services. Computer users can access a vast wealth of information and services by utilizing a wide area network to establish a connection with other computers connected to the network. Indeed, the Internet has quickly become a means for not only obtaining information, but for conducting commercial transactions and retail purchases. For example, as discussed above, the Internet has become a popular resource for consumers to access and monitory their credit history information. Indeed, a variety of on-line services offer users the ability to access credit report data maintained by credit reporting bureaus, such as TransUnion®, Equifax® and Experian®. In fact, some on-line services allow users to obtain credit reports that merge data from multiple credit reporting bureaus.

The requirements associated accessing resources available over the Internet tend to exclude a large segment of potential consumers and/or prevents such credit reporting services to avail themselves of other opportunities for reaching potential consumers. For example, the requirement that a user have a computer connected to the Internet excludes users who do not own a network-enabled computer. Moreover, the prior art requires potential consumers to actively seek out and access the web sites associated with the credit report providers. These conditions are obstacles that credit data reporting services would like to overcome, while nevertheless leveraging their infrastructure dedicated to the provision of on-line credit reporting services.

In light of the foregoing, a need in the art exists for methods, apparatuses and systems that allow consumers to order credit report data using telephone network devices. A need also exists for methods, apparatuses and systems that allow online credit report providers to leverage existing infrastructure and avail themselves of alternative distribution channels that are capable of accessing a large market segment. Embodiments of the present invention substantially fulfill these needs.

### SUMMARY OF THE INVENTION

The present invention provides methods, apparatuses and systems providing a voice-based interface to credit report retrieval systems allowing users to order credit report data using a telephone or similar device. The present invention provides novel functionality and process flows directed to handling a request from a caller for a credit report, while providing a secure and easy-to-use voice interface. In one embodiment, the functionality associated with the present invention allows a customer to access his/her credit score via a telephone or other suitable voice-based device, and optionally have a credit report mailed to his/her address. The use of a voice interface, instead of a traditional graphical user interface associated with web-based services accessible over a client computer, marks a departure from traditional credit reporting product channels and provides an opportunity to access a large market of consumers who do not regularly access the Internet. In one embodiment, the present invention further provides a novel authentication methodology, especially adapted to telephone network devices and other interfaces having limited text entry capabilities, that minimizes the opportunity for malicious users to glean meaningful amounts of authenticating information; i.e. personal information presumably known to an individual that may be used to authenticate identity.

### DESCRIPTION OF THE DRAWINGS

FIG. 1 is a functional block diagram illustrating a computer network environment including a voice-channel-based credit data retrieval system according to one embodiment of the present invention.

FIG. 2 is a flow chart that illustrates the initial process flow wherein an explanation of the service is provided to the user and the user is provided the option to order a credit report.

FIG. 3 is a flow chart providing the call flow associated with processing payment information provided by the user.

FIG. 4 is a flow chart illustrating an authentication process flow according to an embodiment of the present invention.

FIG. 5 is a flow chart setting forth a process flow, according to one embodiment, directed to the credit reporting aspect of the present invention.

FIG. 6A is a flow chart illustrating a call process flow associated with operator transfers.

FIG. 6B is a flow chart providing a process flow associated with disconnecting with users.

### DESCRIPTION OF PREFERRED EMBODIMENT(S)

### I. Overview

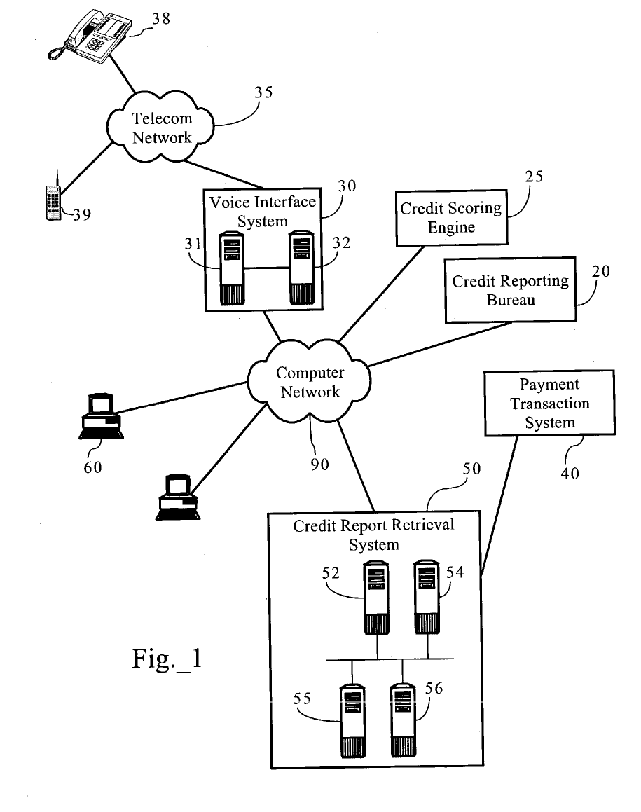

As FIG. 1 provides, an embodiment of the present invention operates in a computer network environment comprising at least one credit reporting bureau 20, credit scoring engine 25, voice interface system 30, payment system 40, and credit data retrieval system 50. Computer network 90 can be any suitable computer network, including the Internet or any wide area network. In one embodiment, credit data retrieval system 50 comprises Web/HTTP server 52, application server 54, database server 56 and web services network gateway 55. Web/HTTP server 52 is operative to establish HTTP or other connections with client computers (or other network access devices) to receive requests for files or other data over computer network 90 and transmit responses in return. In one embodiment, Web/HTTP server 52 passes user requests to application server 54 which composes a response and transmits it to the user via web server 52. In one embodiment, web server 52 establishes a secure connection to transmit data to users and other sites, using the SSL (“Secure Sockets Layer”) encryption protocol part of the HTTP(S) (“Secure HTTP”) protocol, or any other similar protocol for transmitting confidential or private information over an open computer network. Database server 56 stores the content and other data associated with operation of loan rate analysis system. Application server 54, in one embodiment, includes the functionality handling the overall process flows, described herein, associated with credit data retrieval system 50. Application server 54, in one embodiment, accesses database server 56 for data (e.g., HTML page content, etc.) to generate responses to user requests and transmit them to web server 52 for ultimate transmission to the requesting user. Application server 54 is further operative to is further operative to interact with voice interface system 30 through, in one embodiment, network services gateway 55 to allow users to access credit reports with voice-based telephone network devices, such as cell phones, POTS telephones, and web phones, as discussed below. As one skilled in the art will recognize, the distribution of functionality set forth above among web server 52, database server 56 and application server 54 is not required by any constraint. The functionality described herein may be included in a single logical server or module or distributed in separate modules. In addition, the functionality described herein may reside on a single physical server or across multiple physical servers.

As FIG. 1 illustrates, voice interface system 30 is operably connected to telecommunications network 35 to allow users to access credit data retrieval system 50 using a voice-based telephone network device, such as POTS telephone 38 or wireless phone 39, as more fully described below. Specifically, voice interface system 30 provides call process flow functionality, pre-recorded voice-based scripts, and a voice-based and/or DTMF-based interface allowing users, using touch keys on telephones 38 or 39 and/or voice commands, to order credit report data, as well as provide payment and authentication information. In one embodiment, voice interface system 30 includes speech recognition functionality operative to translate voice signal data into text data suitable for further processing. A variety of speech recognition systems are known, all of which can be applied to the present invention. In one embodiment, voice interface system 30 further includes text-to-speech engine that converts text data into computer-generated voice signals recognizable as speech. In one embodiment, voice interface system 30 includes interface server 31 and network services gateway 32. Network services gateway 32 is operative to process and route service requests and responses over computer network 90. Interface server 31 is operably connected to telecommunications network 35 to interact with users at telephones 38 or 39, as more fully described below. In another embodiment, the telephone network device may be a web-based phone implemented by a software application resident on a client computer. Interface server 31 is further operative to compose requests, including data entered by users at telephones 38 or 39, and transmit them to network services gateway 32 for routing (and other related tasks, such as logging) to credit data retrieval system 50. Interface server 31 may also be operative to transfer users to customer service call centers upon a request from a user, or the detection of an error or condition requiring human intervention.

Credit scoring engine 25, in one embodiment, is a web-based application service operative to compute a credit score given a set of credit data. Credit scoring engine 25 is operative to receive credit report data relating to an individual or other entity and process the data against a proprietary or other credit scoring model to yield a credit score. Suitable credit scoring models including a FICO® credit scoring model, CreditXpert®, TransRisk®, or any other suitable credit scoring model. In one embodiment, credit scoring engine 25 is a stand-alone web-based application remote from credit data retrieval system 50 and/or credit reporting bureau 20. In other embodiments, the functionality of credit scoring engine 25, however, is integrated into other components associated with computer network 90. For example, credit scoring engine 25 may be incorporated as an internally executed application (such as CreditXpert) within credit data retrieval system 50, or within credit reporting bureau 20.

Credit reporting bureau 20 maintains a database or other repository of credit history data for at least one individual or other entity, such as the credit reporting services offered by Experian®, Equifax®, and TransUnion®. Credit reporting bureau(s) 20 offer web-based credit reporting application services. In one embodiment, at least one credit reporting bureau 20 includes Address Verification System (AVS) functionality, allowing for verification of addresses associated with individual users. In one embodiment, credit data retrieval system 50 formulates an XML request and transmits it to credit reporting bureau 20 to retrieve credit report data. In one embodiment, at least one credit reporting bureau 20 is operative to access credit scoring engine 25 in response to a request from credit data retrieval system 50; in such an embodiment, the credit reporting bureau 20 transmits the credit reporting data associated with the individual to credit scoring engine 25 and receives a credit score in return. The credit reporting bureau 20 then returns the credit score with the credit report data to credit data retrieval system 50. In one embodiment, credit data retrieval system 50 formulates an XML request and transmits it to credit reporting bureau 20 to retrieve credit report data. In one embodiment, the XML request format includes a flag or other indication of whether a credit score is also desired. Credit reporting bureau 20 responds to the asynchronous or synchronous request by transmitting an XML response including credit report data corresponding to the individual identified in the XML request. In one embodiment, credit data retrieval system 50 operates in connection with one credit reporting bureau, such as TransUnion, Equifax, and Experian; however, in other embodiments, credit data retrieval system 50 obtains credit report data for a particular individual from at least two credit reporting bureaus 20 and merges the data into a single report. Co-pending and commonly owned application Ser. No. 09/644,139 filed Aug. 22, 2000 in the name of Guy et al. and entitled “Credit and Financial Information and Management System” discloses methods and systems that obtain credit report data from multiple sources and merge such data into a single report (incorporated by reference herein).

Payment transaction system 40 corresponds to a payment transaction processing network associated with one of a plurality of different non-cash payment mechanisms, such as credit card or debit card. According to one embodiment, the transaction processing network can be a credit card or debit card transaction processing network, such as VISA®, MASTERCARD®, DISCOVER®, or AMERICAN EXPRESS®. In one embodiment, the transaction processing networks enable users, at telephone 38 or 39, to provide a non-cash method of payment, which credit data retrieval system 50 uses to obtain payment according to well known transaction processing protocols.

As described below, credit data retrieval system 50 is operative to interact directly with voice interface system 30 to receive requests from users at telephones 38 or 39. Credit data retrieval system 50 is further operative to pull credit report data from one or more credit reporting bureaus 20, provide credit scores to users, and, in one embodiment, trigger a mailing system to print out and mail hard copies of credit reports to respective users. In one embodiment, credit data retrieval system 50 includes web/HTTP server 52 operative to receive requests from users via voice interface system 30 and transmit responses in return. Credit data retrieval system 50 further includes network services gateway 55 which implements web services network functionality to process and route service requests and responses over a computer network. In one embodiment, network services gateway 55 implements a communications model based on requests and responses. Network services gateway 55 generates and transmits a service request to an external vendor, such as credit reporting bureau 20 and/or credit scoring engine 25, which receives the request, executes operations on data associated with the request, and returns a response. Network services gateway 55, in one embodiment, further includes other web services functionality such as logging of service requests and responses allowing for tracking of costs and usage of services.

Network services gateways 32 and 55, in one embodiment, rely on secure HTTP communications and XML technologies for request and response formats. In one embodiment, network services gateways 32 and 55 maintain Document Type Definitions (DTDs) and/or schemas that define the format of the XML request and XML response. Request and response DTDs, in one form, include a message type, transaction identification, vendor/service identification, and an application identification.

As one skilled in the art will recognize various embodiments are possible. For example, the credit retrieval functionality of system 50 may be incorporated into the functionality of credit reporting bureau 20. In one embodiment, users may also access credit data retrieval system 50 over computer network 90 with a network access device, such as client computer 60 including suitable client software, such as a web browser. However, suitable network access devices include desktop computers, laptop computers, Personal Digital Assistants (PDAs), and any other wireless or wireline device capable of exchanging data over computer network 90 and providing a user interface displaying data received over computer network 90. In one embodiment, computer network 90 is the Internet; however, computer network 90 may be any suitable wide-area network.

1 Operational Overview of Preferred Embodiment(s)

1.1 Overview

The functionality of credit data retrieval system 50 allows a customer to access his/her credit score via a telephone or other suitable voice-based device and, optionally, have a credit report mailed to his/her address. The use of a voice interface, instead of a traditional graphical user interface associated with web-based services accessible over client computer 60, marks a departure from traditional credit reporting product channels and provides an opportunity to access a large market of people who do not regularly access the Internet. As discussed below, voice interface system 30 captures user input and relays the information to credit data retrieval system 50, which in turn processes the input and provides output to voice interface system 30.

1.2 Distribution Channels

In one embodiment, the services enabled by voice interface system 30 and credit data retrieval system 50 are presented to users in the following ways:

a. To customers waiting on a telephone queue for another service; and

b. To customers dialing voice interface system 30 directly as a result of a direct mail, email or other suitable advertising campaign.

1.3 Credit Data Retrieval System Functionality

In one embodiment, credit data retrieval system 50 includes functionality to:

a. Respond to HTML Post requests initiated by voice interface system 30;

b. Provide a session ID;

c. Capture payment information and indicate its acceptance to voice interface system 30;

d. Capture Social Security Numbers and communicate customer information;

e. Communicate credit scores to users by posting it to voice interface system 30;

f. Store in a database a list of customers who have ordered a credit report;

g. Store in a database error messages initiated by voice interface system 30;

h. Store in a database call-exit data provided by voice interface system 30;

i. Report error messages to voice interface system 30;

j. Maintain a customer profile based on inputted information and purchase history;

k. Communicate with Cybersource or payment system 40 to process payment information;

l. Communicate with an Address Verification System to gain and/or verify customer information;

m. Communicate with credit reporting bureau(s) 20 to obtain credit report data;

n. Run a credit report data through credit scoring engine service 25 to gather a credit score; and

o. Provide offline fulfillment of credit reports and credit analysis to users.

1.4 Flow Overview

The following description sets forth an overall process flow according to one embodiment of the present invention. A customer either dials a number found in an advertisement or has the option of connecting to voice interface system 30 while on hold for another service (for example, while waiting to speak with a representative at a banking institution). The customer hears a summarized pitch for the service(s) offered by credit data retrieval system 50. The user is then provided an option to accept the offer or to hear a more detailed pitch and description of the service. After a description of the services, the user confirms his or her acceptance of the service; in one embodiment, double confirmation by the user is required.

The user is prompted for and enters payment information (e.g., credit card number/expiration date and zip code or coupon number). In one embodiment, voice interface system 30 composes an XML request including the payment information to credit data retrieval system 50. Credit data retrieval system 50 processes the payment information by transmitting it to payment system 40 for processing and responds with a payment accepted or failed message. If payment is accepted, the user enters his or her Social Security Number (SSN). Voice interface system 30 composes an XML request and transmits an HTTP POST, including the Social Security Number (SSN) to credit data retrieval system 50. Credit data retrieval system 50 accesses AVS functionality (a service that uses a SSN to retrieve an address) to obtain the customer's name and address. Credit data retrieval system 50 transmits to voice interface system 30 the user's first name, last name, street name, street number, and zip code in an XML response.

Credit data retrieval system 50 also uses the SSN to begin gathering credit report data and a credit score (e.g., FICO score, CreditXpert score, etc.) from credit reporting bureau 20 and credit scoring engine 25, respectively. The user is prompted for and inputs customer information in attempt to match the data sent by credit data retrieval system 50 to voice interface system 30 for purposes of authenticating his identity. When credit data retrieval system 50 has obtained a credit score, it posts this data to voice interface system 30. In one embodiment, if the user fails authentication, the user is transferred to a customer service representative. Otherwise, if the user passes authentication, voice interface system 30 relays the credit score to the user along with a summarized credit analysis. The user then terminates the call or returns to the original call queue.

2 Voice User Interface Functionality and Specification

2.1 Call Flow

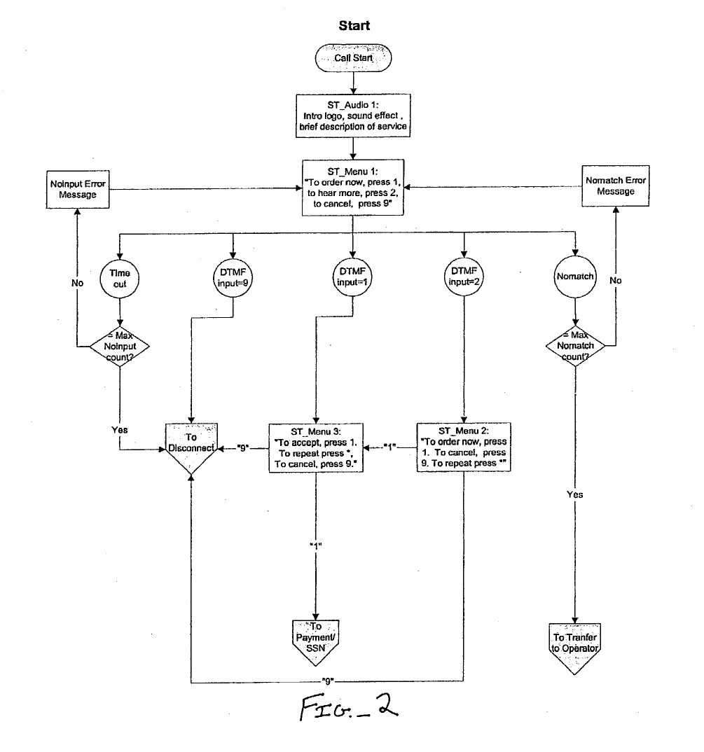

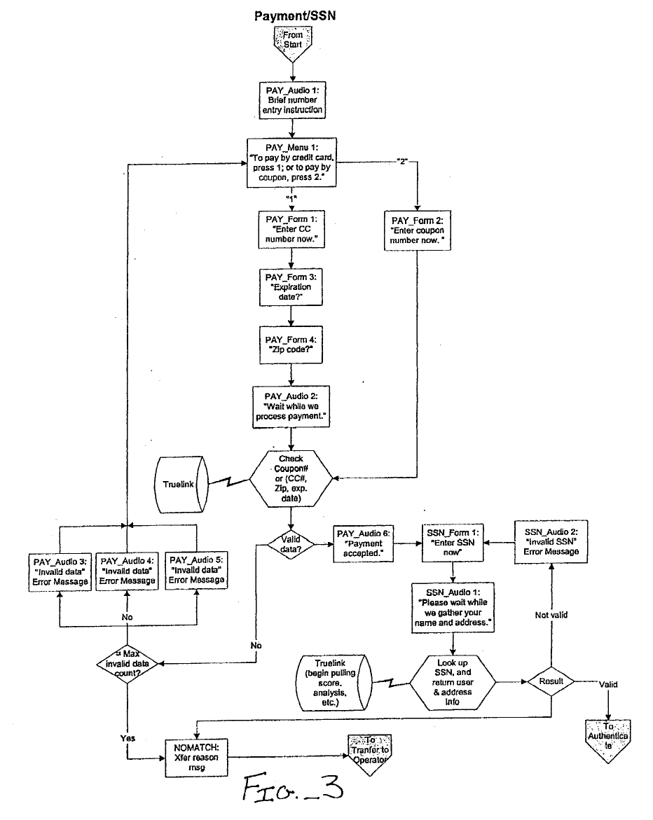

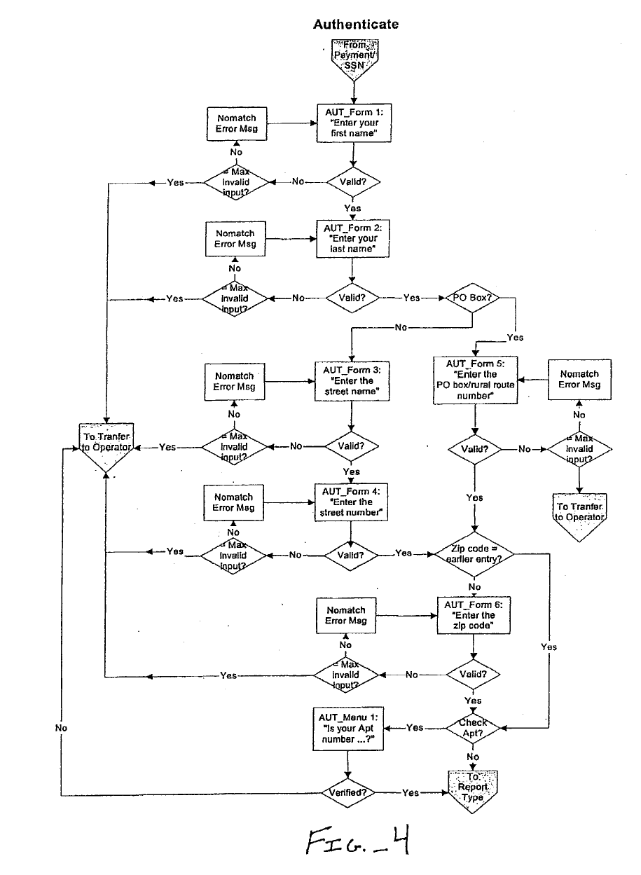

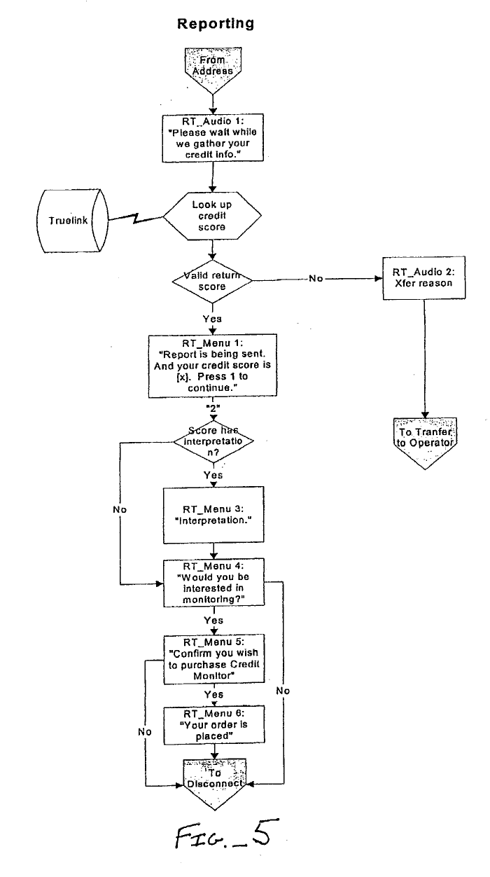

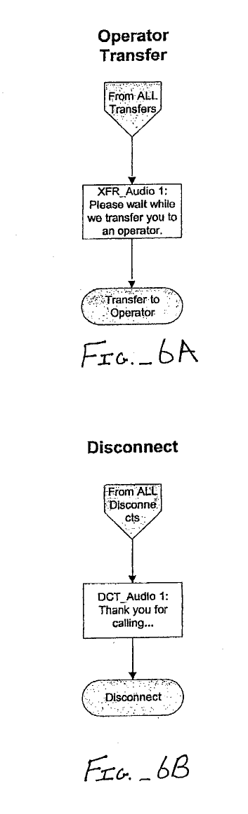

FIGS. 2 thru 6 provide an overview of the call process flow associated with an embodiment of the present invention. FIG. 2 illustrates the initial process flow wherein an explanation of the service is provided to the user and the user is provided the option to order a credit report. FIG. 3 illustrates the call flow associated with processing payment information provided by the user. FIG. 4 illustrates an authentication process flow according to an embodiment of the present invention. FIG. 5 sets forth a process flow, according to one embodiment, directed to the credit reporting aspect of the present invention. FIG. 6A provides a call process flow associated with transferring users to an operator. FIG. 6B shows a process flow associated with disconnecting users. As one skilled in the art will recognize, however, the process flows illustrated in the various figures is a selection from myriad possible process flows.

2.2 Telephone Scripts

Voice interface system 30, in one embodiment, stores pre-recorded voice scripts corresponding to various stages of the call flow. Accordingly, as a user progresses through the call flow, voice interface system 30 is operative to retrieve the appropriate scripts, add appropriate audio data to the script (e.g., such as a credit score provided by credit data retrieval system 50), and present the script to the user. For example, scripts may prompt the user to enter his/her social security number, or select a service by pressing a corresponding number key, report a credit score, explain aspects of the user's credit rating, etc. In one embodiment, voice based-interface system 30 also includes scripts corresponding to various credit profile types and circumstances, and presents them to users as appropriate to the credit history and/or scores generated by credit data retrieval system 50.

3 Exemplary Operating Parameters and Specifications

3.1 Inputs/Outputs

3.1.1 DTMF Format

In one embodiment, where voice interface system 30 employs a DTMF interface, credit data retrieval system 50 converts and transmits numeric data to voice interface system 30. Accordingly, alphabetic strings are converted into their DTMF counterpart. For example, on a telephone keypad, the letter A is represented by the number 2. Therefore, credit data retrieval system 50 converts an “A” into 2 before transferring to data to voice interface system 30. The conversion table, according to an embodiment of the present invention, is:

| Letter | DTMF Number |
|---|---|
| A, b, c | 2 |
| D, e, f | 3 |
| G, h, I | 4 |
| J, k, l | 5 |
| M, n, o | 6 |
| P, q, r, s | 7 |
| T, u, v | 8 |
| W, x, y, z | 9 |

For example, to communicate a street name of “Broadway”, credit data retrieval system 50 would send “27623929”. (Of course, this conversion may be performed by functionality associated with voice interface system 30.) In one embodiment, the converted numeric data is transmitted with the regular text data, where the text data is used by a text-to-speech engine implemented by voice interface system 30.

3.1.2 Payment Request

Voice interface system 30 communicates customer payment information, including whether the customer is paying by credit card or gift coupon, and the credit card specifications (number, expiration date and zip code), to credit data retrieval system 50. The credit card number can be between 12 to 19 digits long. The gift certificate number, in one embodiment, is all numeric and 15 digits long. If the customer has returned a gift coupon number, credit data retrieval system 50 runs it through a coupon redemption tool to verify its authenticity. If it is authentic, credit data retrieval system 50 will return an ‘Ok’ message to voice interface system 30. If the customer has returned a credit card number, credit data retrieval system 50 interacts with Cybersource or payment system 40 to authenticate and process (authorize payment, and later settle the transaction) the credit card payment. If the payment is authorized, credit data retrieval system 50 returns an ‘Ok’ message to voice interface system 30. In addition, either coupon or credit card payment failure results in an error message to voice interface system 30 that results in transferring the customer to a customer service representative.

The returned ‘Ok’ message (SESSION_ID_RESPNSE) also contains a session ID generated by credit data retrieval system 50. In one embodiment, the session ID is sent as an XML element.

3.1.3 SSN Lookup Request

In one embodiment, voice interface system 30 passes a customer's SSN and expects two pieces of information in return from credit data retrieval system 50:

a. Customer address and name (see section 3.1.4),

b. Customer credit score (see section 3.1.5).

3.1.4 Customer Information Response

In order to authenticate a user, voice interface system 30, in one embodiment, requires a customer's first and last name, along with address information (street number, street name, and zip code). To initiate the authentication, voice interface system 30 passes to credit data retrieval system 50 the user's SSN. In turn, credit data retrieval system 50 passes the SSN to an AVS service to acquire the required customer information.

When the customer information is returned to voice interface system 30, the user is required to input this same information for authentication purposes. Voice interface system 30, in one embodiment, detects whether or not there is a match. If there is match, the user authenticates his or her identity. If not, the user is transferred to a customer service representative.

In one embodiment, in order to decrease the number of mismatches, credit data retrieval system 50 implements the following guidelines and protocols before passing customer information to voice interface system 30:

a. The AVS system, in one embodiment, returns the customer information in pre-parsed fields. Credit data retrieval system 50 passes the values of the last name, first name, street number, street name, and zip code fields to voice interface system 30.

b. Credit data retrieval system 50 identifies whether the address is a regular street address or a box/rural route number, and communicates this to voice interface system 30.

c. Before passing the street name field, credit data retrieval system 50 filters out the following instances of text if they occur alone (not within another word): “RR”, “POB”, and “STAR”.

d. The street direction does not need to be filtered out of the street name since this appears in a different field. In one embodiment, credit data retrieval system 50 does not pass the street direction field to voice interface system 30.

e. Before passing the street name field, credit data retrieval system 50 also filters out numerical suffixes such as “ND, RD, TH”. Credit data retrieval system 50, in one embodiment, only filters if these suffixes follow a number. For example remove “RD” from “3^{rd}” but does not remove these suffixes from word instances, such as “Ford”.

f. Credit data retrieval system 50, in one embodiment, also filters from all fields spaces, punctuation, and special characters.

g. Credit data retrieval system 50 filters out letters from the street number field (e.g., “553A Clipper” is filtered to “553 Clipper”).

If the user does not properly authenticate himself, voice interface system 30, in one embodiment, transmits a notification to credit data retrieval system 50 to stop processing the user session. One embodiment of the present invention uses a multiple-choice challenge-response scheme to alleviate the difficulties associated with inputting text using a phone dial pad. In one embodiment, voice interface 30 receives a plurality of addresses from credit data retrieval system 50 with the correct address flagged or otherwise identified. In one embodiment, voice interface system 30 is operative to present the addresses to the user and have the user choose the correct one to properly authenticate himself. This embodiment eliminates the difficulty of entering letters using a dial pad. In an enhanced embodiment, voice interface system 30 breaks up this “multiple choice” into the discrete components of an address. For example, voice interface system 30 presents four different street addresses. If the user correctly enters the street address, voice interface system 30 repeats the process as to the city, and so on. Breaking this address into its elements creates a larger number of potential possible combinations, making it more difficult for a malicious user to repeatedly use the system to deduce another's address. For example, by breaking the address into its elements, a malicious user would only learn one potential element of the address before being denied the credit report. In addition, by starting with the most general address element (state) and working up, the most specific aspect of the address is potentially shielded from the malicious user. This methodology together with an overall limit on the number of voice-based attempts, both within the same call and on an aggregate basis, to retrieve a credit score can be used to protect user credit data against this situation.

3.1.5 Zip Code

If the user is paying by credit card, voice interface system 30, in one embodiment, requires the user to enter the zip code corresponding to the billing address of the credit card account. Later, during identity authentication, the user is also asked to enter a zip code if:

a. He didn't already provide one (for example if he paid with a coupon number), or

b. The first zip code does not match the zip code returned by the AVS service.

Credit data retrieval system 50 determines whether or not the zip code entered with the credit card payment information matches the zip code in the address returned by the AVS service. When responding to the request for customer information, credit data retrieval system 50, in one embodiment, does not include a zip code if a match with the AVS service data did occur. In one implementation, this indicates to voice interface system 30 not to authenticate on the zip code. If the user did not enter a zip code during payment processing, or if the zip code entered does not match the address returned by the AVS service, credit data retrieval system 50 includes a zip code in the message. If there is an error in the zip code format, a separate error element is used for the returned XML and the optional zip code element does not apply.

3.1.6 Credit Score Post

Credit data retrieval system 50, in one embodiment, posts to voice interface system 30 the customer's credit score and a value statement (whether or not the score is considered to be ‘very poor’, ‘poor’, ‘average’, ‘good’, or ‘very good’). Credit data retrieval system 50 may also indicate whether or not there is a credit report or if it is a thin file. As soon as voice interface system 30 sends the SSN to credit data retrieval system 50, credit data retrieval system 50, in one embodiment, begins compiling the credit reports and score. Even though voice interface system 30 does not request credit data until later in the call process flow, this ‘head start’ ensures the data is available in a timely manner. As discussed above, if the user fails authentication, voice interface system 30 notifies credit data retrieval system 50 to allow it to cease processing activities associated with that user. In another embodiment, the initial request from voice interface system 30 including a user name and address will also indicate a request for credit information that credit data retrieval system 50 later answers with an asynchronous response.

3.1.7 Posting Error Messages

In one embodiment, credit data retrieval system 50 notifies voice interface system 30 whenever it encounters an error. Errors may arise from: 1) The credit data retrieval system 50 application, 2) Cybersource (or payment system 40), 3) credit reporting bureau(s) 20, 4) Credit scoring engine 25, 5) The coupon redemption tool, and 6) Internet communication protocols and infrastructure.

3.1.8 Receiving Error/Call-exit Messages

Voice interface system 30 also transmits error messages to credit data retrieval system 50 when it encounters a problem. When there is an error, such as loss of communication between credit data retrieval system 50 and voice interface system 30, or if the payment or identity authentication fails, voice interface system 30 transfers the user to customer support who will then complete the transaction. If the caller disconnects, either willfully or due to a malfunction, the required action depends on its occurrence in the call flow:

a. Disconnect before payment processed: Other than error logging, credit data retrieval system 50 ends the session here.

b. Disconnect after payment processed and before identity confirmation: Credit data retrieval system 50 sends a security mailer to the ‘best’ address.

c. Disconnect after identity confirmation: Credit data retrieval system 50 fulfills the off-line reporting requirements, including the score analysis if its purchase has been indicated.

Errors and disconnects are also logged for reporting purposes (see section 3.3).

3.2 Offline Fulfillment

3.2.1 Credit Reports

In one embodiment, credit data retrieval system 50 includes functionality directed to providing users with hard copies of their credit reports through the mail. Voice interface system 30 posts messages of customers who have purchased a credit report (the score/analysis is included). Credit data retrieval system 50, in one embodiment, batches the requests and sends them to a system for off-line fulfillment. In one embodiment, along with the credit report, customers will be mailed an insert that displays a credit score and gives an analysis of it. The credit report is mailed to the address that the user authenticated against. As discussed above, if this address was not current, the user's attempt to authenticate would have failed, and the issue dealt with by customer service.

In one embodiment, the user has the option of establishing an on-line account with credit data retrieval system, including a user name and password, that allows the user to access credit data retrieval system 50 with a client computer 60 and view the credit report at a later time.

3.3 Reporting/Logging

3.3.1 Real time Reporting

Voice interface system 30, in one embodiment, posts customer call-exit information in real-time. This information will consist of three parts: 1) The session ID, 2) The module (what menu or audio module the user was in before exiting the call flow), and 3) The state (the user's last input). Credit data retrieval system 50 saves and organizes this data so that it can be read intelligently in report form. Credit data retrieval system 50 also enables two call-exit daily reports: 1) A summary report that lists the number of customers that exited at each menu/audio module, and 2) A detail report that lists customers' final input, grouped by menu/audio module. Credit data retrieval system 50 also reports on, a daily basis, system errors reported by credit data retrieval system 50 and voice interface system 30 applications.

3.3.2 Batched Reporting

Voice interface system 30 sends additional call data in batch form. For example, it includes a list of all customer input before a call-exit situation. For example, if a user was transferred to customer service due to three failed input attempts, the batched data will include a list of all three inputs.

3.3.3 Customer Profile

The reported data allows credit data retrieval system 50 to maintain a database of customer profile information based on user input, including: name, credit card information, and purchase history.

Although the present invention has been described relative to specific embodiments, it is not so limited. Many modifications and variations of the embodiments described above will become apparent. For example, although the embodiments described above employed HTTP(S) and XML protocols and technologies, the present invention can use any suitable communications and data exchange technologies and protocols. Furthermore, other changes in the details, steps and arrangement of various elements may be made by those of ordinary skill in the art without departing from the scope of the present invention. Accordingly, the present invention has been described with reference to specific embodiments. Other embodiments of the present invention will be apparent to one of ordinary skill in the art. It is, therefore, intended that the claims set forth below not be limited to the embodiments described above.

What is claimed is:

1. A credit data retrieval and reporting system allowing telephone-based access to credit report retrieval functionality, comprising
a credit data repository maintaining credit history data associated with at least one entity;
a credit scoring engine operative to receive credit report data relating to an individual or other entity and process the data against a credit scoring model to yield a credit score;
a voice interface server operably connected to a telecommunications network to transmit voice signals to and receive voice signals from voice-based telephone network devices; wherein the voice interface server includes call process flow functionality operative to interact with users and generate orders for credit reports;
a credit data retrieval system operative to:
interact with the voice interface server to receive a request for credit report data associated with a user;
access the credit data repository to retrieve credit report data associated with the user;
access the credit scoring engine to retrieve a credit score based on the credit report data associated with the user;
transmit the credit score to the voice interface server in response to the request from the user;
wherein the voice interface server comprises a speech recognition engine operative to convert speech received from voice-based telephone network devices to text, a text-to-speech engine operative to convert text data received from the credit data retrieval system to speech;
and wherein the voice interface server is operative to:
in response to a command from a user, transmit requests for credit report data to the credit data retrieval system;
receive a credit score associated with the user; and
communicate the credit score to the user.

2. The credit data retrieval and reporting system of claim 1 wherein the interface server comprises call process flow functionality operative to:
prompt for and receive information identifying an individual user;
transmit the information to the credit data retrieval system in a message requesting authentication information;
authenticate the user based on the authentication information provided by the credit data retrieval system.

3. The credit data retrieval and reporting system of claim 2 wherein the call process flow functionality is further operative to:
notify the credit data retrieval system of successful and failed authentication attempts; and
provide credit report scores returned from the credit data retrieval system to authenticated users.

4. The credit data retrieval and reporting system of claim 2 further comprising an address verification system operative to return an address associated with an individual user; and wherein the credit data retrieval system, in response to a request including information identifying a user, is operative to retrieve, from the address verification system, an address associated with the user and transmit the address to the voice interface server; and wherein the voice interface server authenticates the user based on the transmitted address.

5. The credit data retrieval and reporting system of claim 3 wherein the credit data retrieval system is further operative to begin processing retrieval of credit report data associated with the user from the credit data repository in response to the request for authentication information; and wherein the credit data retrieval system is operative to terminate the processing in response to a notification that the user has failed authentication.

6. The credit data retrieval and reporting system of claim 1 wherein the interface server comprises call process flow functionality including pre-recorded voice-based scripts associated with the stages of operation of the credit data retrieval and reporting system; and wherein the voice interface server is operative to combine data gathered during interaction with the credit data retrieval system with the voice-based scripts and transmit them to the network telephone device associated with the user.

7. The credit data retrieval and reporting system of claim 1 wherein the voice interface server further comprises a DTMF interface operative to recognize DTMF signals transmitted from a voice-based telephone network device, and wherein the voice interface server is operative to associate DTMF signals with command options.

8. The credit data retrieval and reporting system of claim 1 wherein the voice-based telephone network device is a POTS telephone.

9. The credit data retrieval and reporting system of claim 1 wherein the voice-based telephone network device is a wireless cell phone.

10. The credit data retrieval and reporting system of claim 1 further comprising an off-line mail distribution facility operative to print credit reports and mail the credit reports to users; and wherein the credit data retrieval system, in response from a notification associated with an individual user transmitted by the voice interface server, is operative to trigger the off-line mail distribution facility to print out and mail hard copies of credit reports to the individual user.

11. The credit data retrieval and reporting system of claim 1 wherein the credit scoring engine is incorporated into the functionality of the credit data repository.

12. The credit data retrieval and reporting system of claim 1 wherein the credit data retrieval system further comprising a network services gateway implementing web services network functionality to process and route service requests transmitted by the credit data retrieval system and route responses returned by end systems associated with the service requests.

13. The credit data retrieval and reporting system of claim 12 wherein the credit data repository includes a web services network interface, and wherein the server obtains credit reporting data by accessing the web services network interface by transmitting requests thereto via the network services gateway.

14. The credit data retrieval and reporting system wherein data transmitted between the credit data retrieval system and the voice interface server are formatted as XML messages.

15. A credit data retrieval and reporting system allowing telephone-based access to credit report retrieval functionality, comprising
a credit data repository maintaining credit history data associated with at least one entity;
a credit scoring engine operative to receive credit report data relating to an individual or other entity and process the data against a credit scoring model to yield a credit score;
an off-line mail distribution facility operative to print credit reports and mail the credit reports to users;
a voice interface server operably connected to a telecommunications network to transmit voice signals to and receive voice signals from voice-based telephone network devices; wherein the voice interface server includes call process flow functionality operative to interact with users and generate orders for credit reports;
a credit data retrieval system operative to:
interact with the voice interface server to receive a request for credit report data associated with a user;
access the credit data repository to retrieve credit report data associated with the user;
access the credit scoring engine to retrieve a credit score based on the credit report data associated with the user;
transmit the credit score to the voice interface server in response to the request from the user;
trigger, in response from a request associated with an individual user transmitted by the voice interface server, the off-line mail distribution facility to print out and mail hard copies of credit reports to the individual user;
wherein the voice interface server comprises a speech recognition engine operative to convert speech received from voice-based telephone network devices to text, a text-to-speech engine operative to convert text data received from the credit data retrieval system to speech;
and wherein the voice interface server is operative to:
in response to a command from a user, transmit requests for credit report data to the credit data retrieval system; and
communicate verification that the credit report data has been ordered to the user.

16. The credit data retrieval and reporting system of claim 15 wherein the credit data retrieval system is operative to access information allowing for authentication of individual users, and wherein the interface server comprises call process flow functionality operative to:
prompt for and receive information identifying an individual user;
transmit the information to the credit data retrieval system in a message requesting authentication information;
authenticate the user based on the authentication information provided by the credit data retrieval system; and
transmit a request for credit report data to the credit data retrieval system if the user is authenticated.

17. A method facilitating authentication of users over telephone network devices, comprising
receiving authentication information associated with a user, wherein authentication information includes a plurality of elements, and wherein the plurality of elements includes elements ranging from a most general element to a most specific element;
authenticating the user by
prompting the user for information corresponding to the most general element type;
terminating the authentication, if the information provided by the user does not match the authentication information;
otherwise, repeating the prompting and conditional terminating steps for the next most general element type until the most specific element type is reached or the authentication is terminated.

18. The method of claim 17 wherein the prompting step comprises
formulating a multiple choice authentication challenge, wherein the information corresponding to the element type is one choice in the authentication challenge.

19. The method of claim 17 wherein the authentication information is an address including street address, city, and state elements; and wherein the most general element type is the state element and the most specific is the street address element.

20. The method of claim 17 wherein the address further includes a zip code element.

21. The method of claim 18 wherein the authentication information is an address including street address, city, and state elements; and wherein the most general element type is the state element and the most specific is the street address element.

22. The method of claim 18 wherein the address further includes a zip code element.

23. The method of claim 17 wherein the user is allowed a predetermined number of unsuccessful attempts before the authentication is terminated.
